(19) United States
(12) Patent Application Publication
(10) Pub. No.: US 2020/0327131 A1
(43) Pub. Date: Oct. 15, 2020

(54) METHOD, AN APPARATUS AND A COMPUTER PROGRAM PRODUCT FOR CONTENT EVALUATION

(71) Applicant: M-Files Oy, Tampere (FI)

(72) Inventor: Ossi Nykanen, Tampere (FI)

(21) Appl. No.: 16/378,898

(22) Filed: Apr. 9, 2019

(51) Int. Cl. G06F 16/2455; G06F 16/25; G06F 16/16; G06F 17/27

(52) U.S. Cl. CPC G06F 16/24564; G06F 17/2705; G06F 16/164; G06F 16/252

(57) ABSTRACT

The present embodiments relate to a method and a technical equipment, wherein the method comprises receiving a set of set-valued variable assignments, said set of set-valued variable assignments relating to a content of a data repository; determining an expression to be evaluated, wherein the expression defines a set of successive evaluation conditions for the set of set-valued variable assignments; determine from the set of set-valued variable assignments, which variable combinations satisfy the conditions of the determined expression; providing a set of satisfying variable combinations as a result; and performing an application-specific action according to the result.

### TECHNICAL FIELD

The present solution generally relates to a content evaluation. In particular, the present embodiments relate to a solution for performing evaluation of input data and executing control actions according to the evaluated data.

### BACKGROUND

Due to the explosive amount of digital assets, it has become more crucial to find documents and other files that contain specific type of information or specific pieces of information. The files can be searched by means of keywords that should appear in the content of the file. In addition, metadata-based content solutions ease the finding of the needed files, since the files can be organized in a more structured manner according to the defined metadata.

However, since the amount of data in databases and data repositories continuously increase, the finding of important files becomes more difficult, since the amount of results also increases. Therefore there is a need for more efficient tools for finding relevant data items (such as documents or other files) from a data repository.

### SUMMARY

Now there has been invented an improved method and technical equipment implementing the method, for content evaluation by means of which relevant data items can be efficiently found from a data repository. Various aspects include a method, an apparatus, and a computer readable medium comprising a computer program stored therein, which are characterized by what is stated in the independent claims. Various embodiments are disclosed in the dependent claims.

According to a first aspect there is provided a method comprising
receiving a set of set-valued variable assignments, said set of set-valued variable assignments relating to a content of a data repository;
determining an expression to be evaluated, wherein the expression defines a set of successive evaluation conditions for the set of set-valued variable assignments;
determining from the set of set-valued variable assignments, which variable combinations satisfy the conditions of the determined expression;
providing a set of satisfying variable combinations as a result according to which an application-specific action is performed.

According to an embodiment, the method further comprises generating a new set of set-valued variable assignments comprising the set of satisfying variable combinations and new input variables and performing the method.

According to an embodiment, the method further comprises generating variable combinations for data items of the data repository.

According to an embodiment, the method further comprises processing raw data from the data repository to generate the set of variable assignments.

According to an embodiment, the raw data is composed of one or more of the following: textual data, sensors readings, image data, video data, audio data.

According to an embodiment, the expression to be evaluated is received from a system requesting for the content evaluation.

According to an embodiment, the expression to be evaluated is predefined in a parser.

According to an embodiment, the application-specific action is one of the following: a metadata assignment, reporting, data transfer, control of a device or application-specific task.

According to a second aspect there is provided an apparatus comprising at least one processor, memory including computer program code, the memory and the computer program code configured to, with the at least one processor, cause the apparatus to perform at least the following:
receive set of set-valued variable assignments, said set of set-valued variable assignments relating to a content of a data repository;
determine an expression to be evaluated, wherein the expression defines a set of successive evaluation conditions for the set of set-valued variable assignments;
determine from the set of set-valued variable assignments, which variable combinations satisfy the conditions of the determined expression;
provide a set of satisfying variable combinations as a result; according to which an application-specific action is performed.

According to an embodiment, the apparatus further comprises computer program code configured to cause the apparatus to generate a new set of input variables comprising the set of satisfying variable combinations and new input variables, and performing the method.

According to an embodiment, the apparatus further comprises computer program code configured to cause the apparatus to generate variable combinations for data items of the data repository.

According to an embodiment, the apparatus further comprises computer program code configured to cause the apparatus to process raw data from the data repository to generate the set of variable assignments.

According to an embodiment, the raw data is composed of one or more of the following: textual data, sensors readings, image data, video data, audio data.

According to an embodiment, the expression to be evaluated is received from a system requesting for the content evaluation.

According to an embodiment, the expression to be evaluated is predefined in a parser.

According to an embodiment, the application-specific action is one of the following: a metadata assignment, reporting, data transfer, control of a device or application-specific task.

According to a third aspect there is provided a computer program product comprising computer program code configured to, when executed on at least one processor, cause an apparatus or a system to:
receive set of set-valued variable assignments, said set of set-valued variable assignments relating to a content of a data repository;
determine an expression to be evaluated, wherein the expression defines a set of successive evaluation conditions for the set of set-valued variable assignments;
determine from the set of set-valued variable assignments, which variable combinations satisfy the conditions of the determined expression;
provide a set of satisfying variable combinations as a result according to which an application-specific action is performed.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows a content evaluation system according to an embodiment;

FIG. 2 shows a simplified example of a general operation of a parser module according to an embodiment;

FIG. 3 shows an example of a technical application environment for the parser module;

FIG. 4 shows another example of an operation of the parser module according to an embodiment;

FIG. 5 shows a simplified example of a content management system according to an embodiment;

FIG. 6 shows a simplified example of a technical control system according to an embodiment;

FIG. 7 shows a simplified example of an apparatus according to an embodiment; and

FIG. 8 is a flowchart illustrating a method according to an embodiment.

### DESCRIPTION OF EXAMPLE EMBODIMENTS

In the following, several embodiments will be described in the context of enterprise content management system. It is to be noted, however, that the invention is not limited to content management systems, but is applicable in other environments as well, for example in technical maintenance system. In fact, the different embodiments have applications in any environment where data searches are performed.

The present embodiments aim to provide more efficient tool for finding relevant data items (such as documents or other files) from a data repository. In addition, the present embodiments are able to induce actionable information from the (unstructured) raw data content for example in a business environment.

The challenge to which the present embodiments relate, is threefold. First, the (unstructured) raw data must be analyzed at a low level and organized into induced input variables (the information requirement). Second, the business- or process-related logic rules, understandable by domain experts, need to be designed (the actionable requirement). Third, application-specific actions need to be triggered based on the outcome of the rules (the business or process requirement).

The present embodiments are focused on the second task, specifying a generalized expression parser for the business related or process related rules, because of the related pivotal technical challenges and the business significance. The technical challenges originate from the fact that the preceding variable induction task fundamentally involves repetitive information and vagueness that needs to be captured in a technical sound but intuitive way. The business challenge originates from the fact that it is the business rules that fundamentally scope and justify the whole endeavor: From the information point of view, (unstructured) raw information that cannot be utilized in the business or process rules is useless. From the automation point of view, the business or process actions that are never triggered by the rules are useless as well (since do not scale).

Therefore, the present embodiments relate to a content evaluation system and a content evaluation method, which allow data items that are relevant to particular purposes to be quickly and intuitively identified. As will be discussed more detailed below, a content evaluation system can be configured to perform a content analysis in a data repository by means of a generalized Boolean expression parser, and to search data items from the data repository, extract relevant content data from the data items, and based on the purpose of the search, to provide the data items for further processing or to perform further processing based on the search result.

The present description uses terms that are specified and defined for the present embodiments. These definitions should be used for interpreting the terms:

“A data item” may refer to a document, an image, a video, an audio, a log file, a sensor reading, etc., that is stored in an electronic form in a data repository or in a database or in a memory of an electronic device. Another term for “data item” is “a data object”. When a data item refers to an electronic file, the data item may or may not have metadata. When a data item is a parameter or a sensor reading, such a parameter or a sensor reading can be a value of a metadata of an electronic file. Alternatively, the data item does not need to have any dependency on a metadata.

“A data repository” is a system that at least stores data items and provides (controlled) access mechanism to the data items. Other terms for a data repository are “a (data) vault”, “a (data) storage”, “a repository”, which can be used interchangeably. In some situations, the data repository may refer to a temporal memory location(s) of a device. The only requirement for a data repository is that it is capable of storing—either temporally or permanently—data.

“Content” refers to set of data items being stored in the data repository. Content is application- or device-specific raw data, for example application- or device-specific file formats for various data items. Content can be formed of one or more data items.

“Metadata” refers to information that defines a data item (e.g. an electronic file) and/or is defined with a plurality of data items (e.g. parameters). Metadata comprises set(s) of metadata items (i.e. a metadata property) with value(s). There are file format specific and general metadata, but also intelligent metadata. Intelligent metadata gives such information on the data item, that is meaningful for certain pre-defined purpose, and is (implicitly/explicitly) derivable from the content of the data time.

“Intelligent Metadata Layer” represents a centralized metadata layer for content located in several data repositories.

“An expression” is a set of conditions in view of which the content (i.e. data items) of a data repository is being evaluated. The expression defines which kind of data is expected as a result of evaluation.

The present embodiments are focused onto Boolean expressions mainly for two reasons. First, experts are usually by default familiar with traditional Boolean expressions and hence the learning curve in applications is modest. Second, the True or False evaluation of the Boolean expressions naturally matches the typical actionable business or process requirements (“do or do not”). This escapes the conceptual challenge common in control-like applications, which, when relying onto continuous output, require separate, usually hard to understand, discretization or defuzzification (etc.) step.

It is worth emphasizing that even when working with Boolean expressions (i.e. expressions that evaluate to True of False, with Boolean-valued operators and functions), the present embodiments are in fact not committing only to the commonly applied single-valued, crisp variables. Instead, variables may have one or more values with an associated confidence level. This distinction is very significant since it fundamentally changes the semantics of the Boolean expressions (i.e. which expressions evaluate to True or False). Still, at the superficial level, the (Boolean) expression syntax according to present embodiments looks almost identical with Boolean expressions with, say, the commonly applied Boolean-valued variables.

“A variable” is a specific symbol that appears in a Boolean expression, identified by a prefix character $ in its name. A well-formed Boolean expression can be evaluated to True or False once assigning value(s) to all of the referred variables.

“A variable assignment” involves associating variable symbols with specific value(s) with an established confidence from [0, 1]. Values can be selected from the supported value domains, such as strings, integers, dates, and terms of a controlled vocabulary (also called “value list items”). Variable assignment can also be referred to as “set-valued variable assignment”.

It is appreciated that a single variable may be assigned with several values and confidences. This reflects to a use case, where an object being analyzed has multiple properties or overlapping characteristics. For example, a document may be described using the subject keywords (variable $keyword) Maintenance (0.9), Pump (0.9), and Failure (0.9), and classified (variable $class) as a MaintenanceReport (0.8) and Reclamation (0.7).

The confidences may be specified by the underlying implementation of the variable assignment, and may reflect either the confidence of the entire assignment procedure (such as in text extraction using fixed rules), or specific values (such as in certain machine learning based predictions), when applicable.

“A variable (value) combination” is a complete specification of the variables appearing in the expression. For instance, considering the Boolean expression $keyword==“Failure” && $class==“Reclamation”, and the above variable assignments for $keyword and $class, a single variable combination might be {($keyword, Maintenance, 0.9), ($class, MaintenanceReport, 0.8)}. Note that this particular variable combination evaluates the expression to False and hence does not satisfy the expression. A Boolean expression is satisfied by a set of variable assignments if there is at least one variable combination that satisfies it.

In use cases where performance requirements are loose, the expression evaluation semantics may be extended from “variable (value) combinations” to “value combinations”. In the latter, stronger semantics, the cardinality of the variable assignments is no longer constrained by the (single) variable name in the combinations. The increase of expressiveness, however, is achieved at the expense of evaluation performance.

Nevertheless, this observation emphasizes the nature of the present embodiment, i.e., that despite their familiar syntactical appearance (intentionally, by design), the semantics of the Boolean expressions introduced here are fundamentally different from the Boolean expressions commonly applied in programming languages. For instance, when assuming the (stronger but more expensive) value combination semantics, given the $keyword variable definition {Maintenance (0.9), Pump (0.9), Failure (0.9)}, the Boolean expression $keyword==“Pump” && $keyword==“Failure” is perfectly sensible, and in this case evaluates to True. On the other hand, in the weaker “variable (value) combinations” semantics, the expression evaluates to False because of the restricted cardinality of assignments, by variable names. This is because none of the variable assignments obviously satisfy the expression individually.

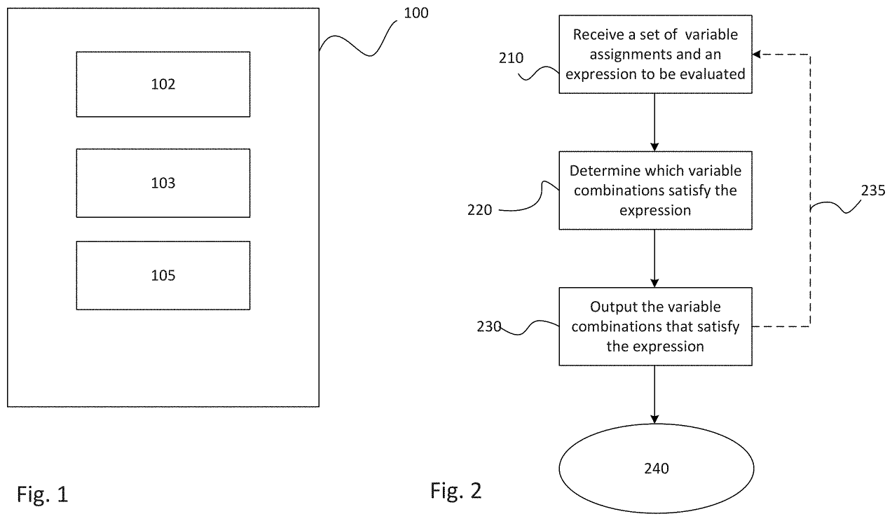

FIG. 1 illustrates an example of a content evaluation system 100. The content evaluation system 100 comprises a parser module 102 (also known as “a parser service”) stored in a memory of the content evaluation system 100. The parser module 102 is able parse the contents of data items according to one or more functions through a communication interface 103. Such a parser module 102 can also be realized as one or more computer devices, configured (e.g., by a computer process or hardware) to perform said one or more functions. The functions of the parser module relate to an algorithm configured to perform successive evaluation steps and manage variable value combination during evaluations. The communication interface 103 can be implemented as one or more interfaces which can be utilized to access the functions of the parser module 102. Such interfaces include APIs, interfaces presented for a web services, web pages, remote procedure calls, remote method invocation, etc. The parser module 102 may also provide an extension mechanism at the expression syntax level, which allows implementing context-aware truth-valued extension functions. These extension functions enable dealing with highly domain-specific deductions, ranging from simple deterministic string processing methods (for instance, checking that a project number refers to a valid PDM (Project Document Management) record, or verifying an electronic signature) to checking that a given variable value can be verified by a real-time physical measurement (for instance, verifying that a given object can be recognized from an real-time image or some other information verified from live a sensor reading).

The content evaluation system may comprise one or more other modules 105, or may be configured to communicate with one or more other modules. Such one or more other modules may be configured to perform, for example, metadata assignment for a data item, reporting, transferring data, controlling of a device or application, application-specific task or other functions. The functionality of said one or more other modules 105 may be based on or may be triggered by the output of the parser module.

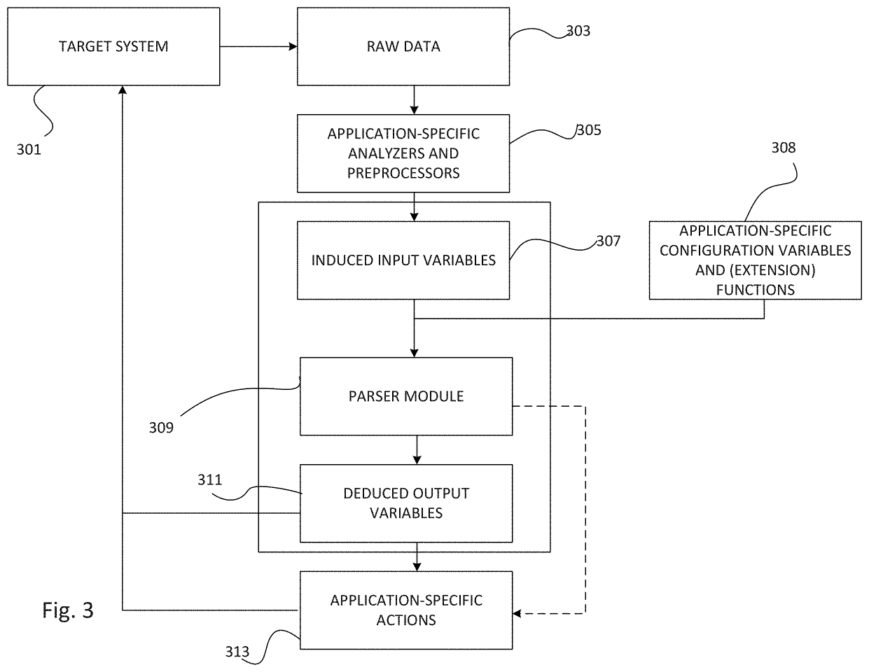

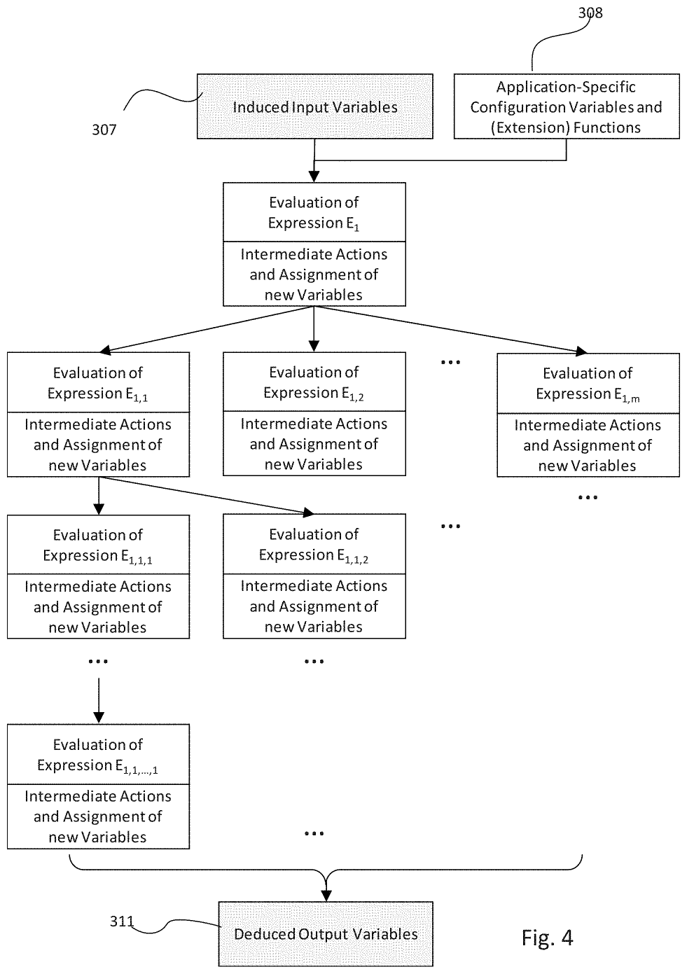

FIG. 2 illustrates a simplified example of a general operation of the parser module. More detailed description will be given with reference to FIGS. 3 and 4. In the example setting of FIG. 2, the parser module receives 210 as input information a set of variable assignments which has been generated from a content of a data repository to be evaluated. In addition, the parser module receives 210 an expression to be evaluated (with contextual extension functions).

The expression to be evaluated is an expression defining which kind of data is expected as a result of the evaluation. The expression (which is discussed in more detailed manner below) defines certain conditions based on which the content evaluation is to be performed.

For example, the expression can be of a format:

### Example 1

```
On such items that satisfy
  ($Category==”LicenseAgreement ” | | $Category==”NDA” | |
  $Category==”SubContractingAgreement”) &&$Date>=”2016-
  01-01”)
do the following...
```

### Example 2

```
On such items that satisfy
  ($Category==”LicenseAgreement” | | $Category==”NDA” | |
  $Category==”SubContractingAgreement”) &&$Date>=”2016-
  01-01”)
do the following
  {On such items that satisfy
  ($Contact==”Mick Johnson” | | $Project==”Construction B”)
  do the following;
  On such items that satisfy
  ($Workflow==”ConstructionProject” &&
  State==”Finished”)
  do the following
  }
```

### Example 3

```
On such items that satisfy
  (Matches($Title, ” (?i) agreement”) &&$Date > ”2017-01-
  21”) | | $Class == ”Agreement”
do the following:
```

where the variables are indicated with “$”, and where “==”, “&&”, “∥” are logical Boolean operators standing for equal, AND-operation, and inclusive OR-operation respectively. The expression comprises an inherent successive conditions for evaluation, in view of which the input variables are evaluated.

The evaluation expression can be received from a system calling the parser module, e.g. from an enterprise management system or a technical control system. In some cases, the expression may be predefined in the parser module, when the parser module has been configured only for certain operation and for certain purpose. The system calling the parser module may comprise the content (i.e. data items) whose evaluation is needed. Alternatively, the system calling the parser module may indicate another repository whose content is expected to be evaluated.

The parser module is configured to determine 220 from the received variable assignments which (sets of) variable combinations having been defined prior the execution of step 220 satisfy the expression, and to provide a set of satisfying variable combinations as a result 230.

The result of the determination, i.e. the satisfying variable combinations, may trigger a set of actions 240. The set of actions may relate to a control of another device or a control or a management of a content being evaluated.

Alternatively or in addition, the result, i.e., the satisfying variable combinations, alongside with new inputs, can be provided 235 as an input to another level of parser module evaluations. In practice, the implementation architecture can thus be either recursive or feed-forward. In the former case, processing may continue indefinitely as a reactive system, while in the latter case, processing may stop in a processor-like or pipeline fashion.

The content evaluation system may be configured as a part of an intelligent enterprise content management system (ECM), or may be an external and connectable through a network, as will be discussed later in this specification. Alternatively, the content evaluation system may be configured as a part of a technical control system, such as a pre-emptive maintenance support system that is configured to analyze technical maintenance and operation reports and physical process sensor readings, and then is configured to trigger appropriate maintenance assignments, alarms, or even emergency control actions, based on its findings. It is appreciated that conceptually the use case relating to the ECM is similar, even though the nature of the sensors and actuators is different from the physical sensors.

FIG. 3 illustrates an example of the technical application environment for the parser module. The technical application environment comprises a target system 301, which may represent any system that has content which is readable and analyzable. The content is stored in a data repository of the target system. The target system 301 may be anything from a large data repository to a specific memory location of a device. The target system 301 comprises application- or device-specific raw data 303, i.e. content, which is wished to be evaluated by the parser module 309. The raw data 303 can contain different types of textual data, documents, sensor readings, image or video data, audio data in their raw format.

In order to perform the evaluation, the content needs to be processed by analyzers and preprocessors 305 to a format that is interpretable by the parser module 309. Therefore, the raw data 303 is induced into input variables and variable assignments 307, suitable for the parser module, for example, text variables, number variables, date variables, variables that are used as references to a metadata structure, etc. (Non-limiting) examples of the variables generated by the preprocessor are $keyword; $class; $category; $ . . . ; and (non-limiting) examples of variable assignments generated by the preprocessor are $keyword: Maintenance (0.9), Pump (0.9), Failure (0.9); $class: MaintenanceReport (0.8), Reclamation (0.7).

The application-specific analyzers and pre-processors 305 may operate in terms of the Intelligent Metadata Layer (IML) compound intelligence services. It is also possible that a pre-processor 305 is one of the other modules of the content evaluation system (shown with reference 105 in FIG. 1). In addition to heuristic processing, the related atomic services include machine-learning based classification, information extraction (from multiple kinds of raw data sources, including non-textual data), and subject matter analysis, to name a few.

In addition to the induced input variables 307, also an expression to be evaluated 308 comprising application-specific configuration variables and functions is taken as an input by the parser module 309. The functions may also comprise extension functions. The expression can be in the form of $keyword==“Failure”&&$class==“Reclamation”.

The parser module 309 is configured to determine (sets of) satisfying variable combinations based on a given expression, and to provide a set of deduced output variables 311. The detailed description on the operation of the parser module 309 is given with respect to FIG. 4.

The evaluation can be performed in subsequent steps in such a manner that when an expression is being evaluated, the results of a previous expression can be utilized. For example, the evaluation can be branched into parallel branches based on the value of e.g. $class variable, and preprocessing and calculation in each branch can be performed differently. As an example, if variable $class has a value “agreement”, the interesting item can be the date of the agreement. On the other hand, if variable $class has a value “repair report”, an identification number of a repaired device can be of interest.

As a very simplified example (in a accordance to weaker semantics), if there is a variable assignment (i.e. variable names and variable values) extracted from a data item:
A: a1, a2, a3
B: b1, b2
   and an expression to be evaluated:
$A==a1∥$A==a2

The expression is evaluated with the given variable assignments, and such variable assignment combinations are determined, which satisfied the expression (if any): It is realized that expression $A==a1∥$A==a2 filters out the variable assignments that do not satisfy the expression.

Therefore, according to the weaker semantics, the satisfying variable assignment combinations would be:

{
{A=a1, B=b1},
{A=a2, B=b1},
{A=a1, B=b2},
{A=a2, B=b2}
}

On the other hand, according to the stronger semantics, the satisfying variable assignment combinations would be:

{
{A=a1},
{A=a1, B=b1},
{A=a2},
{A=a2, B=b1},
{A=a1, A=a2, B=b1},
{A=a1, B=b2},
{A=a2, B=b2},
{A=a1, A=a2, B=b2}
}

It is noted that according to the stronger semantics, not only are there more satisfying combinations, but also the number of evaluations needed for computing them is much higher. The weaker semantics escape this complexity essentially by committing to the simplifying assumptions about the cardinality of the variable assignments, which is reasonable in many practical applications.

The parser module 309 may optionally provide intermediate processing event during the consecutive evaluation steps to be used as application-specific actions 313.

The deduced output variables 311 may also be provided to the target system 301, which can be further processed by the parser module 309. In addition to this or instead, the application-specific actions 313 can be provided to the target system 301.

If the previous expression was used as a basis for a subsequent action, where metadata is defined for a data item, then metadata suggestion Category=$A would generate metadata property suggestions Category=a1 and Category=a2 (but not Category=a3), where “Category” is a metadata property name and “a1”, “a2” are possible property values. Based on the output variables 311, application-specific actions 313 is then performed.

FIG. 4 illustrates an inner workflow of the parser module according to an embodiment in more detailed manner. FIG. 4 relates to steps occurring at the parser module 309 of FIG. 3, when induced input variables 307 and an expression to be evaluated 308 are taken as an input, and deduced output variables 311 are provided as output. On each level of evaluation, the parser module is configured to evaluate the expression and provide intermediate actions and assign new variables for evaluation.

In applications, the overall evaluation comprises more than one evaluation level, wherein evaluations are performed in parallel, tree-like succession, where the evaluated output of the parent expression may be used to trigger for some intermediate processing events, and additional parameter variable assignments are added to each satisfying combination. The results can then be provided as the input for the successor evaluations, leading into several branches or computations, finally providing sets of deduced output variables from each branch, from which the application-specific actions are performed (see FIG. 4).

It is appreciated that from the perspective of a single evaluation step, the confidence of the variable assignments may be taken into account during the evaluation, but the evaluation itself is a Boolean-valued operation: A given variable combination either satisfies the expression or not. Hence, (also) the confidences of the satisfying variables may be “preserved” during evaluation. In applications, where the confidences of the output variables should reflect the (degree of) satisfaction of the input variables (e.g. like in fuzzy control), new intermediate variable assignments can be automatically generated after each successive evaluation step, using appropriate confidence (degree) computation functions (FIG. 4).

As mentioned and also shown in the example of FIG. 4, the parser is configured to perform successive evaluation of files, sensor readings or other data items temporally or permanently stored in a data repository.

An example relating to one use case of the present embodiments is discussed next with reference to elements shown in FIG. 4.

In this use case, two documents X, Y are used as an example.

The document X has content:
“This document is an offer, dated Feb. 21, 2019.
The offer is valid until Mar. 21, 2019 and is targeted to a person Mary Bay.
Best regards, Isaac Middleton”

The document Y has content:
“Thank you for the offer. We accept the offer, and request you to sign the enclosed NDA. Best regards, Mary Bay, Berlin, Mar. 20, 2019”

Both documents X, Y represent the raw data that is obtained from a data repository. The documents are processed by a pre-processor to determine variables and variable assignments suitable for a parser module.

In this example variables $Category, $Date and $Person can be determined. Variables may have been pre-defined for the application, i.e. to indicate the type of the data that is interesting for or is expected by the application. It is to be noticed that at this phase $Date defines only any date without a link to a workflow or a business process.

For example, if the $Date relates to a date until which an offer is valid, such a date can be identified only after the $Category=Offer has been solved. In order to determine such semantic information relating to the date, the determination can be made in two phases. At first $Category is identified, and based on the category, e.g. an offer, all the possible predefined dates relating to the determined category are gone through. For example relating to Category=offer, the possible dates could comprise: Date received, Date send, Date until valid. It is appreciated that an advanced preprocessor might be able to recognize the various kinds of dates, and specify different values to codify the distinction.

The variable assignments determined for the above documents are

Document X:
Category=Offer;
Date=Feb. 21, 2019, Mar. 21, 2019
Person=Mary Bay, Isaac Middleton

Document Y:
Category=Offer, Agreement, NDA
Date: Mar. 20, 2019
Person: Mary Bay

It is to be noticed that the content of the documents has been utilized to generate the variable assignments. For example, when a person name is identified, such person name is assigned for a variable $Person.

The above-generated variable assignments are further processed to define variable combinations as follows:

For simplicity, the variable and the variable assignments can be downsized to their first significant sign(s), e.g. $Category=C; $Date=D; $Person=P; Offer=o, 21.2.2019=21.2, Mary Bay=M etc. and the following variable combinations can be generated (in accordance with the weak semantics):

Variable combinations resulting from document X are

{
{C = O D = 21.2, P = M},
{C = O, D = 21.3, P = M},
{C = O, D = 21.2, P = I},
{C = O, D = 21.3, P = I}
}

It is appreciated that there are 1*2*2=4 combinations, i.e. $Category has only one option, $Date has two options, $Person has two options.

The variable combinations resulting from document Y are

{
{C = O, D = 2, P = M},
{C = A, D = 2, P = M},
{C = N, D = 2, P = M},
}

It is appreciated that there are 3*1*1=3 combinations, i.e. $Category has three options, $Date has one option and $Person has one option.

If the expression to be evaluated is
$Category==agreement && $Person==Mary Bay
   the variables resulting from document Y will fulfill the expression, since the variable combination {C=A, D=2, P=M} satisfies the condition. Therefore, the document Y can be utilized in the subsequent steps.

It is appreciated that the subsequent steps which are based on the fulfillment of the condition of the expression, depends on the application and the situation. Relating to the example above, a metadata of document Y can be fulfilled based on the information found in the variables, or the document Y can be included into a certain workflow, or the document can be migrated, etc.

If the expression to be evaluated is
$Category==NDA $Person==Isaac Middleton
   the variable combinations are regenerated by reducing $Date from the variable combinations. This is possible, cause there is no variable $Date in the expression to be evaluated.

The regenerated variable combinations for document X are thus

{
{C = O, P = M},
{C = O, P = I}
}

i.e. 1*2=2 combinations, which is less than variable combinations including the $Date. The amount of combinations resulting from the document Y is not reduced, since there was only one date in document Y, which does not affect increasingly to the number of combinations. Therefore, the satisfying variable combinations for document Y are still:

{
{C = O, D = 2, P = M},
{C = A, D = 2, P = M},
{C = N, D = 2, P = M},
}

In this simple example, the reduction of variables is not as meaningful as in the situation where there are dozens of variables and their values, whereupon the reduction of one variable reduces the number of evaluation calculations greatly.

Taking the regenerated variable assignments into account, it is realized that variables resulting from both documents X, Y will fulfill the expression, since the variable combination {C=O, P=I} resulting from document_X, and variable combination {C=N, (D=2) P=M} resulting from document Y satisfy the condition.

As a result of the evaluation, both documents X, Y are provided for further processing.

It is appreciated that the expressions given above replaces “if . . . then . . . ” expressions that can be found from major programming languages. The main difference of the expression of present embodiments compared to the “if . . . then . . . ” clause is that
according to present embodiments a variable—identified with sign “$”—is indicated with a set of value assignments, so that the variable can be considered to be a variable with multiple values. This means that each variable can be associated with more than one typed value (e.g. text, number, date, time, term of a controlled vocabulary or a value list). Hence, the condition expression is satisfied if a satisfying variable value combination exists. An evaluation of the expression introduces combinatory structure between the satisfying variable assignments that may be utilized in the next evaluation step (if any).
variable assignments, particularly the values, may also be associated with a confidence level, which can be taken into account in the evaluations. The related process is thus twofold: first, during the preceding variable assignment phase, only values above a certain confidence threshold are accepted, and then in the expression evaluation phase, Boolean-valued functions are intuitively applied, such as require that the confidence of the variable valuation is greater than or equal to the given confidence threshold (implemented e.g., as the function HasConfidenceGE ($Date, “0.8”), wherein “Date” is an example of a variable, and 0.8 is an example of a confidence threshold).
conditional expressions may be applied successively, optionally with multiple conditional branches. For example, as On such items that satisfy (A) do the following {On such items that satisfy (B) do the following; On such items that satisfy (C) do the following}. The satisfying variable value combinations which are passed from A to B and C, must be appropriately filtered, intuitively by removing the variable value combinations that do not satisfy A. For example, in the EXAMPLE 1 above, dates before 2016 should not be included. It is to be noted that within the group A, there is no information nor structure that associates certain variable values together (e.g. categories with specific dates in EXAMPLE 1), but such structure will be available after the evaluation in form of the satisfying combinations in groups B and C.
the expression to be evaluated according to present embodiments provides extension functions for common analytics tasks, such as literal context evaluation (e.g. the literal source of the extracted $Date must appear in some literal context, certain semantic part of a document such as signature area or table, or as a part of a natural sentence), text matching (e.g. $SubSystemId variable must match some calculated code with checksums and be associated to a certain type of a factory system with predefined actuator capabilities, or simply regular expression), and object filtering (e.g. when analyzing objects with factual metadata require certain object filtering to hold, for instance, an object is modified by someone from a certain user group). It should be noted that the extension functions process variables already declared, and that the variable declaration computations may be equally or more sophisticated than the computations related to the extension functions. For instance, a document category (variable $Category) might result from of a machine learning based classification task, the date (variable $Date) from an information extraction task, and assignment of some numerical value from a physical measurement (e.g. $Temperature), etc.).

In the ECM context, the parser module according to present embodiments may be implemented as a service module that is called when e.g. a content analysis in the data repository system is needed. For example, the parser module can be requested to identify sensible, personally identifiable information, for finding important document classes, such as agreements, or for noticing some anomaly in the operation of some control process. Once the parser module is appropriately triggered, subsequent actions may comprise adding automatically metadata to such objects, and/or performing a predefined task. Such tasks include triggering file migration or assignment creation in the ECM context, or triggering series of actions in the pre-emptive maintenance context, using the satisfying variable combinations as the deduced input.

A function block according to the present embodiments can be called as “On Such Items” block, which indicates that any data item fulfilling the evaluation conditions of the block is output for the subsequent operation. The function is written with Boolean expressions composed from variable references, wherein variables may be indicated with $-sign.

The parser module may support other built-in truth-valued functions e.g. for one or more of the following operations: identifying invoices, agreements, or other document classes, identifying data relating to personally identifiable information (e.g. GDPR (General Data Protection Regulation) related data), identifying pre-defined phrases and other structures, etc.

As already mentioned above, the present embodiments support the Boolean operators, comparison operators/functions and parentheses: !, &&, ∥, ==, !=, <, >, <=, >=(,). Since variables may have zero or more values, the functions and the comparison operators have a dual role: 1) they evaluate to true when a given condition is satisfied for some variable value; and 2) they filter out from the subsequent processing such variable values that do not satisfy any of the conditions.

The literal values, including dates and numbers and Booleans, may be written as string literals in a normalized form, for example “2017-01-27”, “123.345” and “true”.

In the following, two use case examples are discussed, where the operation of the parser module is discussed, at first with reference to a data repository system being an ECM system, wherein a content of the repository is being analyzed or searched, and secondly with reference to a technical control system, wherein sensor readings are evaluated and based on them, the system operation is controlled.

Use Case 1:

An Enterprise Content Management (ECM) can also be referred to as an Enterprise Information Management (EIM) system. Such a system is configured to organize and store organizations' electronic documents and other business-related data and/or content. ECM systems may comprises content management systems (CMS), document management systems (DMS) and data management systems. Such systems comprise various features for managing electronic documents and data, e.g. storing, versioning, indexing, searching form, and retrieval of documents. In the context of ECM's, also so called Intelligent Information Management systems are known. Such systems are able to perform more intelligent and higher-level data management which is based in business-critical metadata, for example.

Metadata-based data management comprises operations that can be performed on an object according to its metadata or based on its metadata. For example, a relationship between two or more data objects can be created according to a metadata value. When a person object has, e.g., a metadata value “Comp LTD” for a property “Employer”, such metadata value can be used as a reference to an organization object having a title “Comp LTD”. In addition, workflow states relating to a certain object can be indicated by a metadata value, whereupon a change of state value in a workflow property, shifts the object from a certain state to another.

It is appreciated that such intelligent metadata management is not possible, or is very challenging, with so called traditional, application-specific metadata, that is created for a file and stored within the file, to indicate an author of the file, a creation date, last modified date, etc. For the purposes of the intelligent metadata management, additional metadata is needed. This metadata is derived or extracted from the content of a file, and it may relate to more semantic features of the file.

The enterprise content management system may comprise one or more data repository systems, wherein some of the data repository systems (also referred to as “data vaults”) may be located in an internal network protected by a firewall, and wherein the other data repository systems (also referred to as “external repositories”) may be located outside the internal network. The external repositories can be connected to the data vaults.

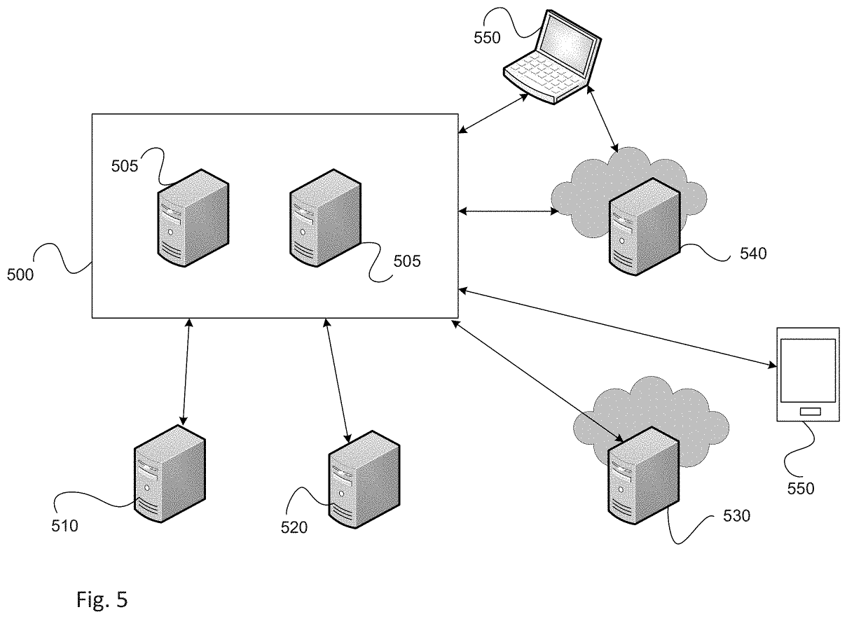

A simplified example of a content management system is illustrated in FIG. 5. The content management system 500 comprises one or more servers and/or internal data storages 505. The content management system 500 can act as a centralized content management system, whereupon the system 500 may also comprise a connection to one or more data repositories 510, 520, 530, 540. It is appreciated that the nature and the number of data repositories can vary in different embodiments. Therefore the present solution is not limited only to the one embodiment being presented by FIG. 5. The content management system 500 further comprises a client application for a client device 550, by means of which the client device 550 is able to operate with the data stored in the content management system 500 and/or any repositories 505, 510, 520, 530, 540. In some embodiments, a client device 350 may also communicate directly with one or more repositories 540. In addition, the content management system 500 comprises a server application for the server device 505. The client application and the server application are able to communicate with each other.

If the content management system 500 is provided with an access to one or more data repositories 510, 520, 530, 540, as shown in FIG. 5, each data repository 510, 520, 530, 540 needs to be integrated and/or connected to the content management system 500. Connecting and/or integrating a data repository 510, 520, 530, 540 to the content management system 500 may be achieved by one or more of the following means:
a) The content management system 500 may comprise connector components that can interact with the technical interfaces of the data repository 510, 520, 530, 540 to access, read, write, delete, modify, process, operate on, and create data in the data repository 510, 520, 530, 540;
b) The content management system 500 may define technical interfaces that a data repository 510, 520, 530, 540 and/or a connector component can implement in order to enable the content management system 500 to access, read, write, delete, modify, and create data in the data repository 510, 520, 530, 540 and/or the system or systems with which the connector component interfaces;
c) The content management system 500 may connect to and/or integrate with data hubs that provide access to one or more data repositories 510, 520, 530, 540 via a unified or partly unified interface or interfaces;
d) The content management system 500 may implement in part or in whole an industry-standard interoperability interface that enables the content management system 500 to interface with any data repository 510, 520, 530, 540 that implements the industry-standard interoperability interface or an appropriate part of it.

Connection and/or integration of a data repository 510, 520, 530, 540 to the content management system 500 may also enable the data repository 510, 520, 530, 540 to access, read, write, delete, modify, process, operate on, and create data in the content management system 300 and/or any data repository 510, 520, 530, 540 connected and/or integrated to the content management system 500. The content management system 500 may comprise a framework that supports pluggable connector components, making it possible to connect new, previously unsupported data repositories to the content management system 500 by adding an appropriate connector component and configuring the connection, without having to make other changes to the content management system 500.

When discussing content with respect to content management, terms “structured content” and “unstructured content” often come up. “Unstructured content” refers to documents, files, whereas “structured content” refers to data objects that may be associated with unstructured content and have a certain pre-defined data structure. For example, with respect to content managements, business objects, such as an organization, a customer, a project, an order, etc. are examples of structured data objects. Such objects are defined with business-critical metadata giving details on the object, and creating relationships between objects. For example, an organization may have a property for a project having a certain value, which value creates a relationship to a corresponding project object.

In the example of FIG. 5, the structured content with or without the associated files can be stored in the internal storage of the content management system 500, whereas the unstructured content can be stored in one or more of the data repositories 510, 520, 530, 540.

The content management system 500 can comprise a content evaluation system according to the present embodiments. Alternatively, the content management system can be connected to the content evaluation system according to the present embodiments.

The content evaluation system according to the present embodiments can be called at the time an evaluation of a data repository is needed. Such a need may occur when important documents or other files are searched for, so that they can be, for example, structured, i.e. provided with metadata.

The parser of the content evaluation system can be defined to find a certain type of content according to the specific function(s).

For example, when the parser is configured to evaluate whether a certain document satisfy the expression (EXAMPLE 1)

($Category==”LicenseAgreement” | | $Category==”NDA” | |
$Category==”SubContractingAgreement”) &&$Date>=”2016-01-01”

the parser is first configured to determine which variable assignments have resulted from the content being evaluated for the different variables $Category, $Date.

As a simplified example, it may have been defined that a document has a variable assignment $Category: LicenseAgreement, when the document contains string “License” or “License agreement” in the content. Similarly, it may have been defined that a document has variable assignment $Category: NDA, when the document contains string “NDA”, “Non-Disclosure Agreement”, “Non-disclosure”, “Confidentiality agreement” or “Secrecy agreement” in the content. Similarly, it may have been defined that a document has variable assignment $Category: SubContractingAgreement”, when the document contains string “Sub-contracting agreement” or “subcontracting agreement” or “subcontractor agreement” or “sub-contract agreement” in the content. As a result, any variable combination of a document that has any of these variables defined by $Category, and has a date later than Jan. 1, 2016, satisfies the expression and is to be provided for further processing.

According to another example, the assignment of the variable values in a production system may also be based on machine learning based prediction. For instance, the variable assignments of $Category and $Date based on machine learning based prediction and information extraction approaches, may provide correct variable assignments only at certain confidence level (at a given time or training data, based on tacit contextual information, such as language or culture context). When speaking of “certain confidence level” for the purposes of the present embodiments, one may think that a certain confidence level means the probability of the given variable assignment to be true. Note that the confidence level is ultimately related to the inner design (and perhaps associated training etc. data) of the component making the variable assignment, and not necessarily only to the individual variable values. This is because of the inherit statistical property of making predictions.

As another example, when the parser is configured to evaluate whether variable combinations of a certain document satisfies the nested conditions as intuitively written as:

($Category==”LicenseAgreement”{$Category==”NDA” {
$Date>=”2016-01-01”) ...

the expression is executed in such a manner that all the documents having the variable combinations fulfilling the condition of $Category==“LicenseAgreement” are passed for the second evaluation round, where documents not having variable combinations fulfilling the condition $Category==“NDA” are filtered out. Therefore, documents having variable assignments fulfilling both $ Category==“LicenseAgreement” and $Category==“NDA” are passed for the date evaluation.

The resulting document set will then be further analyzed e.g. for defining/assigning metadata for the documents or other data objects in order to create business-objects to be stored in the content management system. Alternatively or in addition, a set of (domain or application specific) dependent tasks may be executed. Such tasks include triggering file migration or assignment creation in the ECM context, or triggering series of actions in the pre-emptive maintenance context, using the satisfying variable combinations as the deduced input.

Use Case 2:

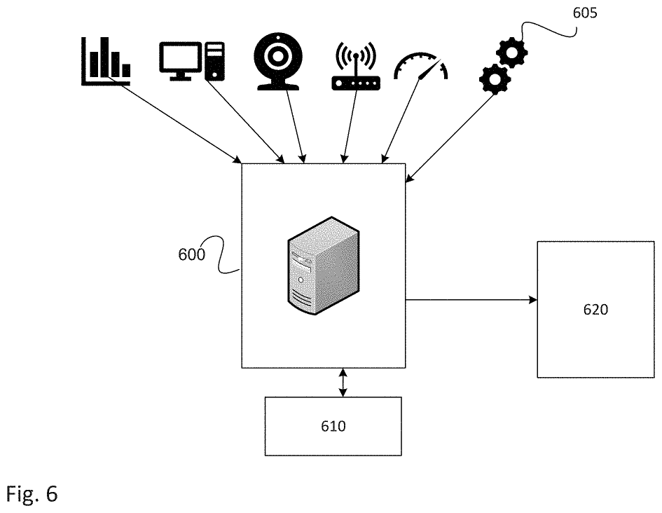

A technical control system, such as a pre-emptive maintenance support system may comprise a central unit being configured to read e.g. sensor data or operation reports. FIG. 6 illustrates an example of a technical control system 600, being connected to various sensors 605. The sensors 605 may provide sensor data directly to the technical control system, e.g. to be stored in a database, or the technical control system 600 can read the sensor data directly from the sensors 605.

The technical control system 600 can comprise a content evaluation system 610 according to the present embodiments. Alternatively, the technical control system 600 can be connected to the content evaluation system 610 according to the present embodiments. The technical control system 600 with the content evaluation system 610 may be configured to analyze, for example, technical maintenance and operation reports and physical process sensor readings according to functions of the content evaluation system. After analysis, i.e., content evaluation, and as a response to the resulted findings, the technical control system 600 is configured to control a specific device 620 or to trigger appropriate maintenance assignments for the specific device 620, to create alarms or even emergency control actions. It is appreciated that the use case relating to the ECM and shown in FIG. 5 is conceptually similar to the example of FIG. 6, even though the nature of the data source as well as the controllable targets are different.

In previous, the operation of the parser module has been discussed. Generally, the parser module evaluates logical conditions based on sets of variable value assignments describing an object of interest (i.e. a data item), which operation results a series of consecutive actions, or a recursive evaluation, affecting the object of interest and/or related objects and systems. The technical effect of the parser module is—amongst other things—the enablement of well-defined processing—i.e., mapping complex evidence into well-established actions—in the first place. This is because in many technical domains, the challenge lies in combining and acting upon several control inputs or evidence based on human expert understandable rules for automated tasks, not generating such inputs or evidence, or providing actuator capabilities per se. Effectively, this provides control into the orchestrated application of the more rudimentary (black box) system components.

Hence, the parser module enables the implementation of actionable technical control based on complicated input information. Depending on the application, the level of such technical control may greatly vary. In the ECM context, it may involve the automated decision of securing GDPR related information, and in the pre-emptive maintenance context, in addition to ECM actions, activating some physical actuator or security measure (and/or notifying responsible personnel). It is appreciated that the generation of the input variables and execution of the subsequent tasks may also involve considerable processing, such as examining live video feed and recognizing artifacts from it.

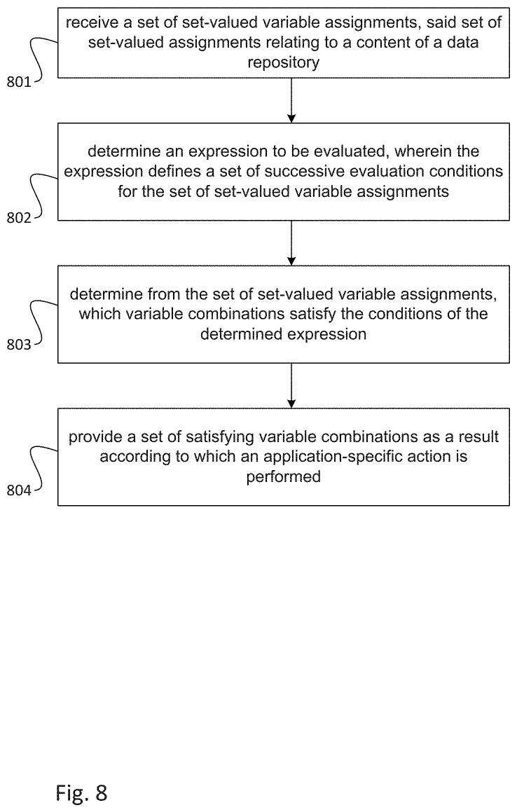

FIG. 8 is a flowchart illustrating a method according to an embodiment. A method comprises receiving 801 set of set-valued variable assignments, said set of set-valued variable assignments relating to a content of a data repository; determining 802 an expression to be evaluated, wherein the expression defines a set of successive evaluation conditions for the set of set-valued variable assignments; determining 803 from the set of set-valued variable assignments, which variable combinations satisfy the conditions of the determined expression; providing 804 a set of satisfying variable combinations as a result according to which an application-specific action is performed.

An apparatus according to an embodiment comprises means for receiving a set of set-valued variable assignments, said set of set-valued variable assignments relating to a content of a data repository; means for determining an expression to be evaluated, wherein the expression defines a set of successive evaluation conditions for the set of set-valued variable assignments; means for determining from the set of set-valued variable assignments, which variable combinations satisfy the conditions of the determined expression; means for providing a set of satisfying variable combinations as a result according to which an application-specific action is performed. The means comprises at least one processor, and a memory including a computer program code, wherein the processor may further comprise processor circuitry. The memory and the computer program code are configured to, with the at least one processor, cause the apparatus to perform the method of FIG. 8 according to various embodiments.

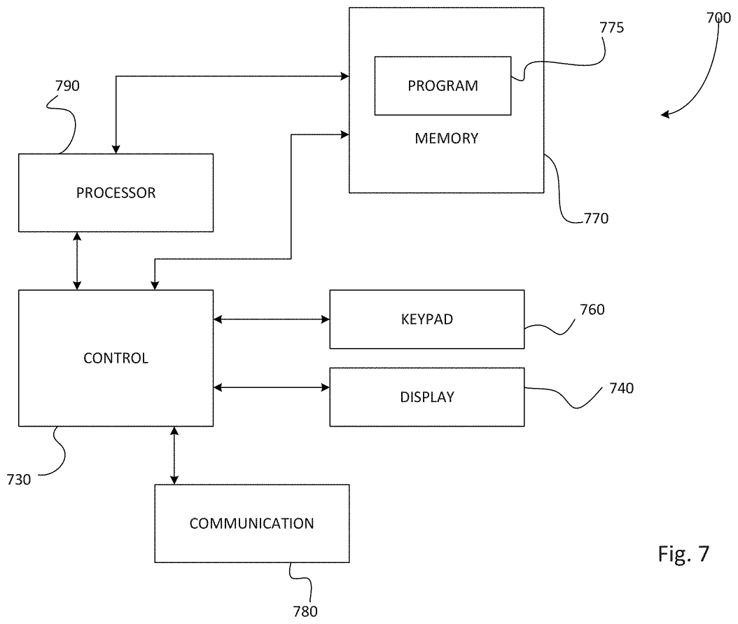

An example of an apparatus is shown in FIG. 7 in a simplified manner. The apparatus 700 may represent a server or client device or a data repository.

The apparatus 700 comprises processing means, such as a processor 790 for processing data. The apparatus 700 further comprises memory means, such as a memory 770, for storing computer program code 775, applications, and various electronic data. The apparatus 500 comprises controlling means, such as a control unit 730, for controlling functions in the apparatus 700. The control unit 730 may run a user interface software to facilitate user control of at least some functions of the apparatus 700. The control unit 730 may also deliver a display command and a switch command to a display 740 to display visual information, e.g., a user interface. The control unit 730 may communicate with the processor 790 and can access the memory 770. Further, the apparatus 700 may comprise input means e.g. in a form of a keypad 760, a keyboard, a stylus, etc. Further, the apparatus 700 comprises various data transfer means, such as a communication block 780 having a transmitter and a receiver for connecting to a network and for sending and receiving information. The communication means can be adapted for telecommunications and/or wide-range and/or short-range communication.

The various embodiments may provide advantages. For example, subsequent processing of set-valued variables in intuitive and introduces a natural structure of satisfying values (the value combination part). The implementation of the parser module enables efficient object analysis and use of confidence as part of the calculation.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment. The computer program code comprises one or more operational characteristics to implement a method according to present embodiments.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1. A method, comprising:
receiving a set of set-valued variable assignments, said set of set-valued variable assignments relating to a content of a data repository;
determining an expression to be evaluated, wherein the expression defines a set of successive evaluation conditions for the set of set-valued variable assignments;
determining from the set of set-valued variable assignments, which variable combinations satisfy the conditions of the determined expression; and
providing a set of satisfying variable combinations as a result according to which an application-specific action is performed.

2. The method according to claim 1, further comprising generating a new set of input variables comprising the set of satisfying variable combinations and new input variables, and performing the method.

3. The method according to claim 1, further comprising generating variable combinations for data items of the data repository.

4. The method according to claim 1, further comprising processing raw data from the data repository to generate the set of variable assignments.

5. The method according to claim 4, wherein the raw data is composed of one or more of the following: textual data, sensors readings, image data, video data, audio data.

6. The method according to claim 1, wherein the expression to be evaluated is received from a system requesting for the content evaluation.

7. The method according to claim 1, wherein the expression to be evaluated is predefined in a parser.

8. The method according to claim 1, wherein the application-specific action is one of the following: a metadata assignment, reporting, data transfer, control of a device or application-specific task.

9. An apparatus comprising at least one processor, memory including computer program code, the memory and the computer program code configured to, with the at least one processor, cause the apparatus to perform at least the following:
receive a set of set-valued variable assignments, said set of set-valued variable assignments relating to a content of a data repository;
determine an expression to be evaluated, wherein the expression defines a set of successive evaluation conditions for the set of set-valued variable assignments;
determine from the set of set-valued variable assignments, which variable combinations satisfy the conditions of the determined expression; and
provide a set of satisfying variable combinations as a result according to which an application-specific action is performed.

10. The apparatus according to claim 9, further comprising computer program code configured to cause the apparatus to generate a new set of input variables comprising the set of satisfying variable combinations and new input variables, and performing the method.

11. The apparatus according to claim 9, further comprising computer program code configured to cause the apparatus to generate variable combinations for data items of the data repository.

12. The apparatus according to claim 9, further comprising computer program code configured to cause the apparatus to process raw data from the data repository to generate the set of variable assignments.

13. The apparatus according to claim 12, wherein the raw data is composed of one or more of the following: textual data, sensors readings, image data, video data, audio data.

14. The apparatus according to claim 9, wherein the expression to be evaluated is received from a system requesting for the content evaluation.

15. The apparatus according to claim 9, wherein the expression to be evaluated is predefined in a parser.

16. The apparatus according to claim 9, wherein the application-specific action is one of the following: a metadata assignment, reporting, data transfer, control of a device or application-specific task.

17. A computer program product comprising computer program code configured to, when executed on at least one processor, cause an apparatus or a system to:
receive a set of set-valued variable assignments, said set of set-valued variable assignments relating to a content of a data repository;
determine an expression to be evaluated, wherein the expression defines a set of successive evaluation conditions for the set of set-valued variable assignments;
determine from the set of set-valued variable assignments, which variable combinations satisfy the conditions of the determined expression; and
provide a set of satisfying variable combinations as a result according to which an application-specific action is performed.

18. A computer program product according to claim 17, wherein the computer program product is embodied on a non-transitory computer readable medium.
